(19) United States
(12) Patent Application Publication
(10) Pub. No.: US 2020/0172043 A1
(43) Pub. Date: Jun. 4, 2020

(54) CLOSING STRUCTURE FOR PRESSURE-RESISTANT CONTAINER, FORMATION METHOD THEREFOR, GAS GENERATOR USING CLOSING STRUCTURE FOR PRESSURE-RESISTANT CONTAINER, AND MANUFACTURING METHOD THEREFOR

(71) Applicant: DAICEL CORPORATION, Osaka-shi, Osaka (JP)

(72) Inventors: Teppei HANANO, Tatsuno-shi (JP); Shuichi SHONAI, Tatsuno-shi (JP)

(73) Assignee: DAICEL CORPORATION, Osaka-shi, Osaka (JP)

(21) Appl. No.: 16/615,306

(22) PCT Filed: Jun. 6, 2018
(86) PCT No.: PCT/JP2018/021686

§ 371 Date: Nov. 20, 2019

(30) Foreign Application Priority Data
Jun. 20, 2017 (JP) 2017-120296

(51) Int. Cl. B60R 21/264; B60R 21/261

(52) U.S. Cl. CPC B60R 21/264; B60R 2021/26029; B60R 21/261

(57) ABSTRACT

According to an embodiment of the present invention, provided is a closing structure of a pressure-resistant container in which an opening of a metallic cylindrical container is closed by a metallic closing member, the closing member including a closing part, the closing part including a first surface, a second surface on an opposite side to the first surface in a thickness direction, and a circumferential surface part between the first surface and the second surface, and having a same shape as that of the opening and having a size enabling insertion thereof into the opening. The closing structure includes: the closing member that is inserted to be at an inside of the opening of the cylindrical container, with the second surface facing inside of the cylindrical container; an annular deformed part that is deformed, with a peripheral wall part on the opening of the cylindrical container abutting against the first surface of the closing part of the closing member and a first annular corner part at a boundary between the first surface and the circumferential surface part; and a welded part where a contact portion between the first annular corner part of the closing part of the closing member and the annular deformed part is welded from outside.

### TECHNICAL FIELD

The present invention relates to a closing structure for a pressure-resistant container, a gas generator using the closing structure of the pressure-resistant container, a formation method for forming the closing structure of the pressure-resistant container, and a manufacturing method for manufacturing the gas generator using the closing structure of the pressure-resistant container.

### BACKGROUND ART

In various technical fields, there may be a need for a container that requires air tightness for preventing moisture from entering from outside and requires resistance against pressure from inside. For example, in a gas generator used for an airbag device mounted in a vehicle, the gas generator is configured to prevent moisture from entering from outside and prevent gas generated upon actuation from leaking out of a part other than a gas discharge port by, first, placing necessary components through an opening of a container (housing), and thereafter, closing the opening by using an igniter including a closing member or an igniter collar, an O-ring, or the like.

JP 2010-184559 A illustrates, in FIG. 1, a gas generator 1 including a cylindrical housing 10. An igniter 16 is disposed on one end side of the cylindrical housing 10, and the igniter 16 is fixed by a metallic igniter collar 17 and a resin 18. Furthermore, as illustrated in FIG. 1, one end side of the cylindrical housing 10 is crimped radially inward thereby causing the metallic igniter collar 17 and the cylindrical housing 10 to be brought into close contact with each other, and also an O-ring is disposed. In this way, both the air tightness and the pressure resistance are enhanced.

U.S. Pat. No. 8,702,125 B illustrates, in FIG. 1, an inflator 14 including a cylindrical housing 12. An igniter 32 is disposed on one end side of the cylindrical housing 12, and a cylindrical member is disposed between the igniter 32 including an igniter collar and the cylindrical housing 12, this cylindrical member having a small thickness and including an end 24 that is closed and another end that is opened on an opposite side thereto.

### SUMMARY OF INVENTION

A first aspect of the present invention (hereinafter referred to as a “first aspect”) provides a closing structure of a pressure-resistant container in which an opening of a metallic cylindrical container is closed by a metallic closing member,

the closing member including a closing part, the closing part including a first surface, a second surface on an opposite side to the first surface in a thickness direction, and a circumferential surface part between the first surface and the second surface, and having a same shape as that of the opening and having a size enabling insertion thereof into the opening,

the closing structure including:

the closing member that is inserted to be at an inside of the opening of the cylindrical container, with the second surface facing inside of the cylindrical container;

an annular deformed part that is deformed, with a peripheral wall part on the opening side of the cylindrical container abutting against the first surface of the closing part of the closing member and a first annular corner part at a boundary between the first surface and the circumferential surface part; and

a welded part where a contact portion between the first annular corner part of the closing part of the closing member and the annular deformed part is welded from outside.

A second aspect of the present invention (hereinafter referred to as a “second aspect”) provides a closing structure of a pressure-resistant container in which a cylindrical opening of a metallic container is closed by a metallic closing member,

the closing member including a closing part, the closing part including a first surface, a second surface on an opposite side to the first surface in a thickness direction, and a circumferential surface part between the first surface and the second surface, and having a same shape as that of the cylindrical opening and having a size enabling insertion thereof into the cylindrical opening,

the closing structure including:

the closing member that is inserted to be at an inside of the cylindrical opening, with the second surface facing inside of the metallic container;

an annular deformed part that is deformed, with a peripheral wall part on the cylindrical opening abutting against the first surface of the closing part of the closing member and a first annular corner part at a boundary between the first surface and the circumferential surface part; and

a welded part where a contact portion between the first annular corner part of the closing part of the closing member and the annular deformed part is welded from outside.

A further aspect of the present invention provides a gas generator in which a gas source is filled in a housing including a gas discharge port, and a component including an igniter actuated by an ignition current is provided in an opening of the housing,

the gas generator using the closing structure of the pressure-resistant container according to the first aspect and the second aspect in the opening to which an igniter at least including an igniter collar is fixed.

A further aspect of the present invention provides a formation method for forming the closing structure of the pressure-resistant container described above, and a manufacturing method for manufacturing the gas generator including the closing structure of the pressure-resistant container described above.

### BRIEF DESCRIPTION OF DRAWINGS

An aspect of the present invention will be more fully understood from the detailed description given hereinbelow and the accompanying drawings, which are given for explanation only and do not limit the present invention.

FIG. 1 includes FIGS. 1A to 1D, and FIG. 1A illustrates a partial cross-sectional view of a pressure-resistant container including a closing structure in an axis X direction according to an embodiment of the present invention, FIG. 1B illustrates a partial enlarged cross-sectional view of FIG. 1A, FIG. 1C illustrates a partial enlarged cross-sectional view in an embodiment different from that illustrated in FIG. 1A, and further FIG. 1D illustrates a partial enlarged cross-sectional view in an embodiment different from that illustrated in FIGS. 1A and 1B.

FIG. 2 illustrates a partial cross-sectional view in an embodiment different from that illustrated in FIG. 1.

FIG. 3 illustrates a cross-sectional view in an embodiment different from that in each of FIGS. 1 and 2.

FIG. 4 illustrates a cross-sectional view in an embodiment different from that illustrated in each of FIGS. 1 to 3.

FIG. 5 illustrates an axial cross-sectional view in an embodiment of a gas generator including the closing structure according to the embodiment of the present invention.

FIG. 6 illustrates an axial cross-sectional view in another embodiment of the gas generator including the closing structure according to the embodiment of the present invention.

FIG. 7 illustrates a partial cross-sectional view in an axial direction in still another embodiment of the gas generator including the closing structure according to the embodiment of the present invention.

FIG. 8 illustrates a partial cross-sectional view in an axial direction in yet another embodiment of the gas generator including the closing structure according to the embodiment of the present invention.

FIG. 9 illustrates an axial cross-sectional view in yet another embodiment of the gas generator including the closing structure according to the embodiment of the present invention.

FIG. 10 includes FIGS. 10A and 10B, and FIG. 10A illustrates a partial cross-sectional view illustrating a closing structure of related art and FIG. 10B illustrates a partial cross-sectional view illustrating a state where pressure is received from inside in FIG. 10A.

### DESCRIPTION OF EMBODIMENTS

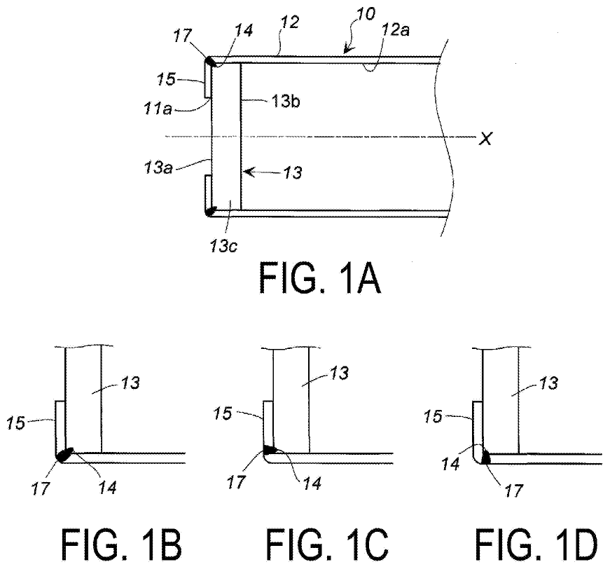

In FIG. 1 of U.S. Pat. No. 8,702,125 B, the cylindrical housing 12 includes a portion radially facing the ignition collar of the igniter 32, with this portion being crimped inward to make both the cylindrical housing 12 and the cylindrical member having a small thickness abut against the igniter collar, whereby, it is considered that both air tightness and pressure resistance are enhanced.

An aspect of the present invention provides on the basis of a method entirely different from that in the abovementioned related art a closing structure of a pressure-resistant container with increased air tightness and pressure resistance, a gas generator using the closing structure of the pressure-resistant container, a formation method for forming the closing structure of the pressure-resistant container, and a manufacturing method for manufacturing the gas generator using the closing structure of the pressure-resistant container.

A cross-sectional shape in a width direction of the metallic cylindrical container is not particularly limited, and may be circular, elliptical, polygonal, or the like. The metal of the metallic cylindrical container and the metal of the metallic closing member may be the same or different from each other.

As for metal hardness of the metallic cylindrical container and metal hardness of the metallic closing member (e.g., Vickers hardness), the metal hardness of the metallic closing member may be higher or lower than the metal hardness of the metallic cylindrical container, and the effect of the embodiments of the present invention can be achieved in the metallic closing member having the lower hardness.

The closing structure of the pressure-resistant container of a first aspect includes a closing member, an annular deformed part, and a welded part where a contact portion between a first annular corner part of the closing member and the annular deformed part is welded from outside.

The metallic closing member may include a closing part, and the closing part may include a first surface, a second surface on an opposite side to the first surface in a thickness direction, and a circumferential surface part between the first surface and the second surface, having a same shape as that of an opening and a size enabling insertion thereof into the opening.

The metallic closing member may be, depending on a state of an opening to be closed, a plate-like member, a lump-like member thicker than the plate-like member, or a lump-like or thick plate-like member including a portion protruding from a part thereof outward in the axis direction, and in these configurations, the closing member conforms to the closing part. In addition, an embodiment may be possible in which the metallic closing member is a lump-like or thick plate-like member including a plate-like part (an annular protruding part) protruding radially outward from a part thereof, and the annular protruding part serves as the closing part in such a configuration.

The annular deformed part is a part where a peripheral wall part on the opening of a cylindrical container is bent inward, a part where the peripheral wall part on the opening of the cylindrical container is reduced in a diameter thereof, or the like.

The welded part rather than serves to maintain the pressure resistance of the closing structure by the welding itself, serves seal a gap between the cylindrical container and the closing member and generate a shearing stress on the annular deformed part when the closing member is subjected to pressure from inside, and thereby, prevent the closing member from falling off, which is caused by a bending stress being generated and the shape of the annular deformed part being restored (returned to the shape before deformation).

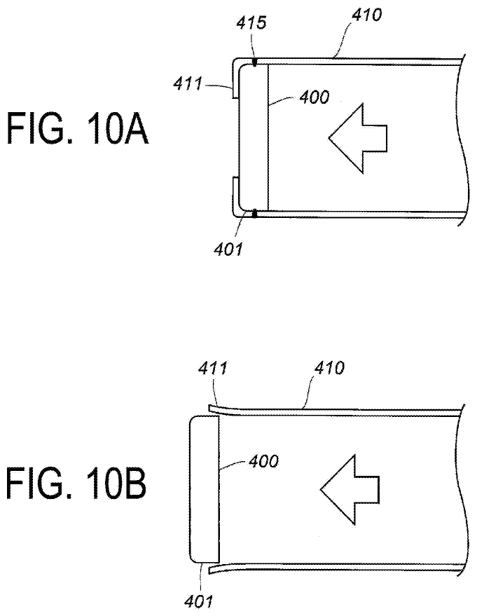

Thus, a fixing function of the closing member is exhibited in the annular deformed part, which is formed by a crimping or the like, and a sealing function is exhibited in the welded part. Here, the welded part is formed on a portion of the cylindrical container corresponding to the first annular corner part, and the first annular corner part is welded together with the cylindrical container, and thus, when a load is applied, a shearing stress is generated in the welded part and a withstand load is increased, compared when welding is performed on other portions. For example, as illustrated in FIG. 10A, in a closing structure where a closing member 400 (here, a corner seen in the cross-sectional view, that is, a portion that corresponds to the first annular corner part includes an annular curved surface) is fixed by a crimped portion 411 of a cylindrical container 410 and a welded part 415 between the cylindrical container 410 and a circumferential surface 401 of the closing member 400, when pressure is applied from inside, the welded part 415 first breaks. Additionally, a bending stress is generated on the crimped portion 411.

In general, because of a relationship, i.e., shearing stress>bending stress, after the breakage occurs in the welded part, the crimped portion 411 is deformed to be pushed out and expanded outward as illustrated in FIG. 10B, and thus, the closing member 400 falls off, and therefore, a withstand load is lower than the breaking of the crimped portion 411 due to the shear.

In the gas generator 1 in FIG. 1 of JP 2010-184559 A, because a corner of the metallic igniter collar 17 (the corner corresponding to the first annular corner part) is not formed with a curved surface at the corner that is ascertained in the cross-sectional view, therefore, when a large load is applied, the corner digs into the crimped portion to generate a shearing stress. As described above, the withstand load is large because of the relationship, i.e., shearing stress>bending stress, therefore, the state illustrated in FIG. 1 of JP 2010-184559 A is maintained even when a load is applied, and the change as illustrated in FIGS. 10A to 10B does not occur. However, in order to dig the corner of the igniter collar 17 into the crimped portion, the metal forming the igniter collar 17 needs to be a member having high hardness, which leads to a higher material cost.

In the first aspect of the present invention, the welded part between the first annular corner of the closing member and the annular deformed part of the metallic container described above function in the same manner as when the metallic igniter collar is formed from a material having high hardness, whereby a shearing stress is generated in the welded part. Therefore, it is not necessary to form a corner that digs into the crimped portion on the closing member (which reduces a machining accuracy for the shape of the corner), and more options for a method of machining the closing member become available. The wording “reduce a machining accuracy” means that even if a curved surface or a flat surface is somewhat formed on the corner, the withstand load is maintained as much as the shearing stress.

Note that because the first annular corner part is fused at the welded part described above, the exhibition of the shearing stress is caused by the welded part, and is different from that in the fixing structure of the gas generator 1 in FIG. 1 of JP 2010-184559 A.

The closing structure of the pressure-resistant container of a second aspect and the closing structure of the pressure-resistant container of the first aspect are different from each other only in the container shape and structure, and the closing structures themselves are same. The pressure-resistant container of the second aspect need only include one cylindrical opening, but may include a plurality of cylindrical openings. In the case where a plurality of cylindrical openings are provided, the closing structure of the pressure-resistant container of the second aspect is formed in part or all of a plurality of cylindrical openings.

The cylindrical opening may have a shape protruding outward from a container body, or may have a shape formed in a recess formed inside the container without protruding outward from the container body. The cylindrical opening may be directly connected to the container body, or may be connected to the container body via another member.

The gas generator according to an embodiment of the present invention can be adopted to a pyro-type gas generator using only a gas generating agent as a gas generating source, or a hybrid inflator using a gas generating agent, argon, helium, and the like as a gas generating source.

Depending on a form of the gas generator, the housing may be cylindrically shaped or disk-shaped. A disk-shaped housing has a length (L) shorter than the cylindrical housing and a diameter (D) larger than the cylindrical housing (i.e., the disk-shaped housing has L/D smaller than that of the cylindrical housing).

When the gas generator uses a cylindrical housing, the closing structure of the pressure-resistant container of the first aspect, in which a gas discharge port is formed, can be used as the cylindrical housing. In this configuration, the closing structure of the first aspect can be used on one end side or both end sides. For instance, examples of this configuration include a gas generator having an opening on one end side that is closed with an igniter including a metallic collar (a closing member) fixed thereto, an opening on the other end side that is closed by a plate-like closing member, and having a plurality of gas discharge ports that are provided to the peripheral wall part.

On the opening side on one end, a contact portion between the first annular corner part of the metallic collar (where an opposite side in the axial direction is a second annular corner part) and the cylindrical housing is welded thereby forming the closing structure of the first aspect. On the opening side on other end, a contact portion between the first annular corner part of the plate-like closing member (where an opposite side in the axial direction is a second annular corner part) and the cylindrical housing is welded thereby forming the closing structure of the first aspect.

When the gas generator uses a disk-shaped housing, the closing structure of the pressure-resistant container of the second aspect, in which a gas discharge port is formed can be used as the disk-shaped housing. For example, in a housing including a top plate, a bottom plate on an opposite side in the axial direction to the top plate, and a peripheral wall part including a gas discharge port between the top plate and the bottom plate, a gas generator in which a cylindrical opening of the bottom plate is closed by an igniter including a metallic collar (a closing member) can be used.

On the cylindrical opening, a contact portion (where an opposite side in the axial direction is a second annular corner part) between the first annular corner part of the metallic collar and the cylindrical housing is welded thereby forming the closing structure of the second aspect.

An embodiment of the present invention provides a formation method for forming the closing structure of the pressure-resistant container according to the first aspect, the formation method including:

inserting the closing member to be at an inside of an opening of the cylindrical container, with a second surface of a closing part facing inward and a first surface facing outward;

deforming a peripheral wall part on the opening side of the cylindrical container until the peripheral wall part abuts against a first annular corner part of the closing part of the closing member to form an annular deformed part; and

welding from outside a contact portion between the first annular corner part of the closing part of the closing member and the annular deformed part.

An insertion position of the closing part of the closing member in the first step is slightly inward from the opening, taking into account a length of the deformed portion in the second step.

As the deformation method in the second step, a method of complete bending as illustrated in FIG. 10A and a method of decreasing the diameter as illustrated in FIG. 1 of JP 2010-184559 A may be adopted. As a specific deformation method, a rolling-crimping method or the like may be adopted.

In the welding in the third step, when the contact portion between the first annular corner part and the annular deformed part can be welded, the welding can be implemented to the annular deformed part from an oblique direction with respect to the axial direction, from a front in the axial direction, and from a direction orthogonal to the axial direction. Examples of the welding method include laser welding and electron beam welding.

An embodiment of the present invention provides a formation method for forming the closing structure of the pressure-resistant container according to the second aspect described above, the formation method including:

inserting the closing member to be at an inside of the cylindrical opening with a second surface of a closing part facing inward and a first surface facing outward;

deforming a peripheral wall part on the cylindrical opening until the peripheral wall part abuts against a first annular corner part of the closing part of the closing member to form an annular deformed part; and

welding from outside a contact portion between the first annular corner part of the closing part of the closing member and the annular deformed part.

The formation method for forming the closing structure of the pressure-resistant container of the second aspect and the formation method for the closing structure of the pressure-resistant container of the first aspect are different from each other in a position where the closing member is attached, because the container shapes thereof are different from each other, but can be performed in the same process.

An embodiment of the present invention provides a manufacturing method for manufacturing a gas generator including the closing structure of the pressure-resistant container of the first aspect described above, the manufacturing method including

providing and arranging a gas source and another component, as necessary, in a cylindrical container including a gas discharge port that formed in advance (first step),

inserting an igniter including a metallic igniter collar provided with the closing part from a first end opening of the cylindrical container (second step),

deforming a peripheral wall part on the first end opening side of the cylindrical container until the peripheral wall part abuts against a first annular corner part of a closing part of the igniter collar to form a first annular deformed part (third step), and

welding from outside a contact portion between the first annular corner part of the igniter collar and the first annular deformed part (fourth step).

Examples of another component arranged as needed in the first step include a filter and a retainer.

A position of inserting the igniter including the metallic igniter collar including a portion to be the closing part in the second step is slightly inward from the opening, taking into account a length of the deformed portion in the third step.

As the deformation method in the third step, a method of complete bending as illustrated in FIG. 10A and a method of decreasing the diameter as illustrated in FIG. 1 of JP 2010-184559 A may be adopted. As a specific deformation method, a rolling-crimping method or the like may be adopted.

In the welding in the fourth step, when the contact portion between the first annular corner part of the igniter collar and the first annular deformed part can be welded, the welding can be implemented to the first annular deformed part from an oblique direction with respect to the axial direction, from a front in the axial direction, and from a direction orthogonal to the axial direction. Examples of the welding method include laser welding and electron beam welding.

Note that the cylindrical container used in the first step may be a container including a closed opening on any one of the ends of the cylindrical container, or a container including an opening on any one of the ends of the cylindrical container to which a component including a gas discharge port (a cup-shaped diffuser portion) is fixed by welding or the like. The cup-shaped diffuser portion includes a gas discharge port formed in one or both of a peripheral wall part and a bottom face part of a metallic cup.

An embodiment of the present invention provides a manufacturing method for manufacturing a gas generator including the closing structure of the pressure-resistant container of the second aspect described above, the manufacturing method including:

providing and arranging a gas source, an igniter, and another component, as necessary, in a metallic container including a gas discharge port formed in advance;

inserting an igniter including a metallic igniter collar provided with the closing part to be at an inside of a cylindrical opening of the metallic container, with a second surface of the closing part facing inward and a first surface facing outward;

deforming a peripheral wall part of the cylindrical opening of the metallic container inward until the peripheral wall part abuts against a first annular corner part of the igniter collar to form an annular deformed part, and

welding from outside a contact portion between the first annular corner part of the closing member and the annular deformed part.

The manufacturing method for manufacturing the gas generator including the closing structure of the second aspect and the manufacturing method for manufacturing the gas generator including the closing structure of the first aspect are different from each other in a position where the closing member is attached because the container shapes thereof are different from each other, but can be performed in the same process.

The closing structure of the pressure-resistant container according to an embodiment of the present invention increases reliability of the product because the closing structure is maintained even when receiving pressure from inside.

The pressure-resistant container according to an embodiment of the present invention can be utilized as a pressure-resistant container for applications in which, for instance, pressure is applied from inside, in various technical fields, and can be used particularly in a closing structure including a housing in a gas generator of an airbag device mounted in an automobile.

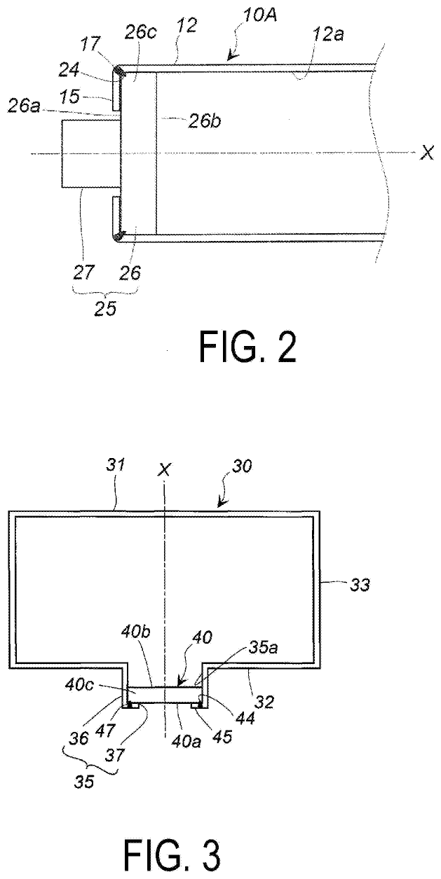

### (1) Pressure-Resistant Container Including Closing Structure Illustrated in FIG. 1 and FIG. 2

A pressure-resistant container (a cylindrical container including a closing structure) 10 illustrated in FIG. 1 has a closing structure including a closing member 13, an annular deformed part 15, and a welded part 17.

The pressure-resistant container 10 includes a first end opening 11a, a second end opening (not illustrated) on an opposite side thereto in the axis X direction, and a peripheral wall part 12. The pressure-resistant container 10 has a circular cross-section in a width direction and is formed from metal such as iron or stainless steel.

The plate-like closing member (a closing part) 13 includes a first surface 13a, a second surface 13b on an opposite side to the first surface 13a in a thickness direction, and a circumferential surface part 13c between the first surface 13a and the second surface 13b. A planar shape of the plate-like closing member (a closing part) 13 is the same circular shape as that of the first end opening 11a of the cylindrical container (a pressure-resistant container) 10 and has a size that enables insertion thereof into the first end opening 11a.

The plate-like closing member 13 is made from metal such as iron or stainless steel, and preferably has a hardness higher than a hardness (Vickers hardness) of the pressure-resistant container 10, but the effect according to an embodiment of the present invention can be achieved even when the closing member 13 has the hardness equal to or less than the hardness (Vickers hardness) of the pressure-resistant container 10. For example, when the hardness (Vickers hardness) of the pressure-resistant container 10 is 100%, the hardness (Vickers hardness) of the plate-like closing member 13 can be selected preferably from a range of 10% to 270%, and more preferably from a range from 60% to 160%.

Before the annular deformed part 15 is formed, the plate-like closing member 13 is inserted into the pressure-resistant container 10 by an amount which is approximately equal to a thickness of the plate-like closing member 13 from the first end opening 11a, with the second surface 13b facing the inside of the pressure-resistant container 10, the first surface 13a facing the outside, and the circumferential surface part 13c being abutted against an inner wall surface 12a of the pressure-resistant container 10.

The annular deformed part (a crimped portion) 15 is a part where the peripheral wall part 12 on the first end opening 11a side of the pressure-resistant container 10 is crimped inward. The annular deformed part is crimped to make the annular deformed part 15 abut against both a first annular corner part 14 and the first surface 13a, with the first annular corner part 14 being at a boundary between the first surface 13a and the circumferential surface part 13c of the closing member 13.

The welded part 17 is a part where a contact portion between the first annular corner part 14 of the closing member 13 and the annular deformed part 15 is welded from outside. An opposite side of the first annular corner part 14 in the axis X direction is a second annular corner part.

The welded part 17 can be configured according to the embodiment illustrated in FIGS. 1B to 1D.

In the embodiment of FIG. 1B, the contact portion between the first annular corner part 14 of the closing member 13 and the annular deformed part 15 is welded in an oblique direction with respect to the axis X of the pressure-resistant container 10 in FIG. 1A. The welding is implemented from a corner of the annular deformed part (a crimped portion) 15 to the first annular corner part 14.

In the embodiment of FIG. 1C, the contact portion between the first annular corner part 14 of the closing member 13 and the annular deformed part 15 is welded in the same direction as that of the axis X of the pressure-resistant container 10 in FIG. 1A. The welding is implemented from a planer part of the annular deformed part (a crimped portion) 15 to the first annular corner part 14.

In the embodiment of FIG. 1D, the contact portion between the first annular corner part 14 of the closing member 13 and the annular deformed part 15 is welded in a direction orthogonal to the axis X of the pressure-resistant container 10 in FIG. 1A. The welding is implemented from the peripheral wall part 12 on the first end opening 11a side to the first annular corner part 14.

In all the embodiments of FIGS. 1B to 1C, the first annular corner part 14 after the welding is in a state of including no corner.

In the pressure-resistant container 10 illustrated in FIG. 1, when a pressure is applied from inside to the second face 13b of the closing member 13, a shearing stress is generated in the welded part 17. In other words, a withstand load of the shearing stress is superior compared to when a bending stress is generated on the annular deformed part 15, hence the annular deformed part 15 does not assume a state illustrated in FIG. 10B, and the closing structure is maintained. Note that in the embodiment illustrated in FIG. 1, an O-ring is not illustrated, but an O-ring may be used or may not be used.

Next, a formation method for forming a closing structure of the pressure-resistant container 10 illustrated in FIG. 1 will be described.

In a first step, the closing member (a closing part) 13 is inserted to be at the inside of the first end opening 11a of the pressure-resistant container 10, with the second surface 13b facing inward and the first surface 13a facing outward. At this time, taking into account a length of forming the annular deformed part 15 in the next step (a length of folding in a swaging process), a position of inserting the closing member 13 is adjusted. A protruding or stepped stopper may be formed on the inner wall surface 12a to determine a depth of inserting the closing member 13.

In a second step, the peripheral wall part 12 on the first end opening 11a side of the pressure-resistant container 10 is crimped until the peripheral wall part 12 abuts against both the first surface 13a of the closing member 13 and the first annular corner part 14 to form the annular deformed part 15.

In addition to a rolling-crimping method using a rolling-crimping tool described in JP 2017-39142 A, rolling-crimping methods described in paragraphs 0037 and 0038 in JP 2007-223485 A and a paragraph 0035 in JP 2008-241186 A are also applicable.

In a third step, the contact portion (a welded part 17) between the first annular corner part 14 of the closing member 13 and the annular deformed part 15 is welded from outside. Examples of the welding method include laser welding and electron beam welding. The welded part 17 is configured according to the embodiment illustrated in FIG. 1B, but may also be configured according to the embodiments illustrated in FIGS. 1C and 1D.

A pressure-resistant container (a cylindrical container including a closing structure) 10A illustrated in FIG. 2 has a closing structure including a closing member 25, an annular deformed part 15, and a welded part 17.

The closing member 25 includes a circular base part 26 and a columnar part 27 provided perpendicularly to the base portion 26.

The base part 26 is inserted into the pressure-resistant container 10A by an amount approximately equal to a thickness of the base part 26 from the first end opening 11a, with a second surface 26b of the base part 26 facing the inside of the pressure-resistant container 10A, a first surface 26a thereof facing the outside, and a circumferential surface part 26c thereof abutting against an inner wall surface 12a of the pressure-resistant container 10A.

The annular deformed part (a crimped portion) 15 is a part where the peripheral wall part 12 on the first end opening 11a side of the pressure-resistant container 10A is crimped inward. The annular deformed part 15 is crimped to make the annular deformed part 15 abut against both a first annular corner part 24 and the first surface 26a, with the first annular corner part 24 being at a boundary between the first surface 26a and the circumferential surface part 26c of the base part 26 of the closing member 25.

The welded part 17 is configured according to the embodiment illustrated in FIG. 1B, but may also be configured according to the embodiment illustrated in FIGS. 1C and 1D.

In the pressure-resistant container 10A illustrated in FIG. 2, when pressure is applied from inside to the second face 26b of the closing member 25 (the base part 26), a shearing stress is generated to the welded part 17. This shearing stress is superior in a withstand load compared to the bending stress on the annular deformed part 15, hence the annular deformed part 15 does not assume a state illustrated in FIG. 10B, and the closing structure is maintained.

The closing structure of the pressure-resistant container 10A of FIG. 2 can be formed in the same manner as the pressure-resistant container 10 of FIG. 1.

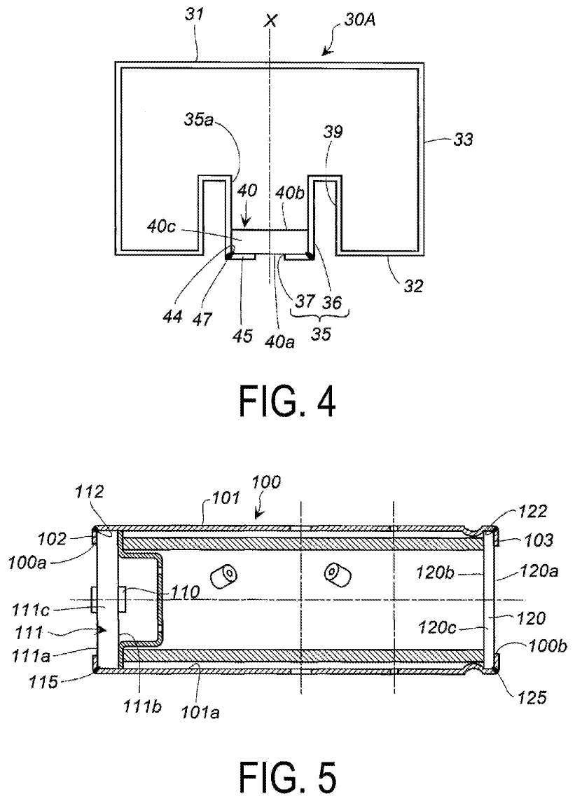

### (2) Pressure-Resistant Container Illustrated in FIG. 3 and FIG. 4

A pressure-resistant container 30 illustrated in FIG. 3 has a closing structure including a closing member 40, an annular deformed part 45, and a welded part 47.

The pressure-resistant container 30 illustrated in FIG. 3 includes: a container body including a top plate 31, a bottom plate 32 on an opposite side to the top plate 31 in the axis X direction, and a peripheral wall part 33 between the top plate 31 and the bottom plate 32; and a cylindrical opening 35 formed in a central portion of the bottom plate 32.

In the embodiment illustrated in FIG. 3, the container body and the cylindrical opening 35 are integrally formed, but an embodiment may be adopted in which the container body and the cylindrical opening 35 are formed as separate members, and the cylindrical opening 35 as the separate member is inserted from a hole on the bottom plate 32 and arranged, and then the contact portion therebetween is integrated by a fixing method using welding, press-fitting, retainer, or the like.

The pressure-resistant container 30 may also be provided as divided two parts of a top plate 31 side and a bottom plate 32 side, since components are arranged therein, and when this configuration is employed, the two parts are combined to be welded together into one form for use.

The cylindrical opening 35 includes a cylindrical wall part 36 and a tip opening 37.

The pressure-resistant container 30 has the top plate 31 and the bottom plate 32 each having a circular planar shape, and is made from metal such as iron or stainless steel.

The plate-like closing member (a closing part) 40 includes a first surface 40a, a second surface 40b on an opposite side to the first surface 40a in a thickness direction, and a circumferential surface part 40c between the first surface 40a and the second surface 40b. A planar shape of the plate-like closing member 40 is the same circular shape as that of the tip opening 37 of the cylindrical opening 35 and has a size that enables the insertion into the tip opening 37.

The plate-like closing member 40 is made from metal such as iron or stainless steel, and preferably has a hardness higher than a hardness (Vickers hardness) of the pressure-resistant container 30, but the effect according to an embodiment of the present invention can be achieved even when the closing member 40 has the hardness equal to or less than the hardness (Vickers hardness) of the pressure-resistant container 30. For example, when the hardness (Vickers hardness) of the pressure-resistant container 30 is 100%, the hardness (Vickers hardness) of the plate-like closing member 40 can be selected preferably from a range from 10% to 270%, and more preferably selected from a range from 60% to 160%.

Before the annular deformed part 45 is formed, the plate-like closing member 40 is inserted into the pressure-resistant container 30 by an amount approximately equal to a thickness of the plate-like closing member 40 from the tip opening 37, with the second surface 40b facing the inside of the pressure-resistant container 30, the first surface 40a facing the outside, and the circumferential surface part 40c being abutted against by an inner wall surface 35a of the cylindrical wall part 36.

The annular deformed part (a crimped portion) 45 is a part where the cylindrical wall part 36 on the tip opening 37 side of the cylindrical opening 35 is crimped inward. The annular deformed part 45 is crimped to make the annular deformed part 45 abut against both a first annular corner part 44 and the first surface 40a, with the first annular corner part 44 being at a boundary between the first surface 40a and the circumferential surface part 40c of the closing member 40.

The welded part 47 is a part where a contact portion between the first annular corner part 44 of the closing member 40 and the annular deformed part 45 is welded from outside. The welded part 47 is configured according to the embodiment illustrated in FIG. 1C, but may also be configured according to the embodiment illustrated in FIGS. 1B and 1D.

In the pressure-resistant container 30 illustrated in FIG. 3, when pressure is applied from inside to the second face 40b of the closing member 40, a shearing stress is generated in the welded part 47. This shearing stress is superior in a withstand load compared to the bending stress on the annular deformed part 45, hence the annular deformed part 45 does not assume a state illustrated in FIG. 10B, and the closing structure is maintained.

Note that in the embodiment illustrated in FIG. 3, an O-ring is not illustrated, but an O-ring may be used or may not be used.

Next, a formation method for forming a closing structure of the pressure-resistant container 30 illustrated in FIG. 3 will be described.

In a first step, the closing member 40 is inserted to be at the inside of the tip opening 37 of the cylindrical opening 35 protruding from the bottom plate 32 of the pressure-resistant container 30, with the second surface 40b facing inward and the first surface 40a facing outward. At this time, taking into account a length of forming the annular deformed part 45 in the next step, a position of inserting the closing member 40 is adjusted. A protruding or stepped stopper may be formed on the inner wall surface 35a to determine the position of the closing member 40.

In a second step, the cylindrical wall part 36 on the tip opening 37 side of the cylindrical opening 35 is crimped until the cylindrical wall part 36 abuts against both the first annular corner part 44 and the first surface 40a of the closing member 40 to form the annular deformed part 45. As the swaging method, a rolling swaging method similar to that described above is applicable.

In a third step, the contact portion (a welded part 47) between the first annular corner part 44 of the closing member 40 and the annular deformed part 45 is welded from outside. An opposite side of the first annular corner part 44 in the axis X direction is a second annular corner part. Examples of the welding method include laser welding and electron beam welding.

The welded part 47 is configured according to the embodiment illustrated in FIG. 1C, but may also be configured according to the embodiment illustrated in FIGS. 1B and 1D.

The pressure-resistant container 30A illustrated in FIG. 4 is the same as the pressure-resistant container 30 in FIG. 3, except that the forming position of the cylindrical opening is different.

Because the cylindrical opening 35 is formed in a recess 39 formed in the base plate 32, the cylindrical opening 35 does not have a structure in which the cylindrical opening 35 protrudes from the base plate 32 unlike the pressure-resistant container 30 illustrated in FIG. 3.

### (3) Gas Generator Illustrated in FIG. 5

A gas generator 100 illustrated in FIG. 5 is the same as the gas generator 10 illustrated in FIG. 1 of JP 2011-225069 A, except for having the closing structure according to an embodiment of the present invention. The gas generator 100 illustrated in FIG. 5 has the closing structure according to an embodiment of the present invention applied to both end openings of a cylindrical housing 101.

An igniter 110 including an igniter collar 111 is disposed on a first end opening 100a.

The igniter collar 111 includes a second surface 111b facing inward, a first surface 111a facing outward, and a circumferential surface part 111c abutting against an inner wall surface 101a of the cylindrical housing 101.

The effect according to an embodiment of the present invention can be achieved whichever relationship between the cylindrical housing 101 and the igniter collar 111 may mutually have, the relationship being a relationship, i.e., the hardness of the igniter collar 111>the hardness of the cylindrical housing 101, or a relationship, i.e., the hardness of the igniter collar 111<the hardness of the cylindrical housing 101.

The cylindrical housing 101 on the first end opening 100a side is crimped inward to form a first annular deformed part 102. The first annular deformed part 102 is folded to abut against the first surface 111a of the igniter collar 111 and a first annular corner part 112, which is a boundary between the first surface 111a and the circumferential surface part 111c.

A contact portion (a welded part 115) between the first annular deformed part 102 and the first annular corner part 112 is welded from outside. The welded part 115 is configured according to the embodiment illustrated in FIG. 1B, but may also be configured according to the embodiment illustrated in FIGS. 1C and 1D.

A plate-like closing member (a closing part) 120 is disposed on a second end opening 100b side on an opposite side to the first end opening 100a in the axial direction.

The closing member 120 includes a second surface 120b facing inward, a first surface 120a facing outward, and a circumferential surface part 120c abutting against an inner wall surface 101a of the cylindrical housing 101.

The cylindrical housing 101 on the second end opening 100b side is crimped inward to form a second annular deformed part 103. The second annular deformed part 103 is folded to abut against the first surface 120a of the closing member 120 and a first annular corner part 122, which is a boundary between the first surface 120a and the circumferential surface part 120c.

A contact portion (a welded part 125) between the second annular deformed part 103 and the first annular corner part 122 is welded from outside. The welded part 125 is configured according to the embodiment illustrated in FIG. 1B, but may also be configured according to the embodiment illustrated in FIGS. 1C and 1D.

Next, a manufacturing method for manufacturing the gas generator 100 illustrated in FIG. 5 will be described.

In a first step, the metallic plate-like closing member 120 is inserted to be at the inside of the second end opening 100b of the cylindrical housing 101, in which the gas discharge outlet is formed, with the second surface 120b facing inward, the first surface 120a facing outward, and the circumferential surface part 120c abutting against the inner wall surface 101a of the cylindrical housing.

In a second step, the peripheral wall part on the second end opening 100b side of the cylindrical housing 101 is crimped until the peripheral wall part abuts against the first surface 120a of the closing member 120 and the first annular corner part 122 to form the second annular deformed part 103.

At this time, taking into account a length of forming the second annular deformed part 103 in the crimping step (a length of folding in the crimping process), a position of inserting the closing member 120 is adjusted. A protruding or stepped stopper may be formed on the inner wall surface 101a to determine a depth of insertion of the closing member 120.

As the swaging method, a rolling-crimping method similar to that described above can be applied.

In a third step, a gas generating agent, an igniter, a cylindrical filter, and a retainer are provided and arranged from the first end opening 100a side in the cylindrical housing 101.

In a fourth step, the igniter 110 including the metallic igniter collar 111 is inserted to be at the inside of the first end opening 100a of the cylindrical housing 101, with the second surface 111b facing inward, the first surface 111a facing outward, and the circumferential surface part 111c abutting against the inner wall surface 101a of the cylindrical housing. At this time, taking into account a length of forming the first annular deformed part 102 in the crimping step, a position of inserting the igniter 110 (the igniter collar 111) is adjusted. A protruding or stepped stopper may be formed on the inner wall surface 101a to determine a depth of inserting the igniter collar 111.

In a fifth step, the peripheral wall part on the first end opening 100a of the cylindrical housing 101 is crimped until the peripheral wall part abuts against the first surface 11a of the igniter collar 111 and the first annular corner part 112 to form the first annular deformed part 102.

In a sixth step, a contact portion (a welded part 115) between the first annular corner part 112 of the igniter collar 111 and the first annular deformed part 102 is welded from outside, and a contact portion (a welded part 125) between the first annular corner 122 of the closing member 120 and the second annular deformed part 103 is welded from outside. Examples of the welding method include laser welding and electron beam welding.

Each of the welded part 115 and the welded part 125 is configured according to the embodiment illustrated in FIG. 1B, but may also be configured according to the embodiment illustrated in FIGS. 1C and 1D.

Note that the cylindrical housing 101 used in the first step may be a housing that is provided with, in advance, a gas discharge port formed on the peripheral wall part, or a housing including the second end opening 100b of the cylindrical housing 101 to which a component (a cup-shaped diffuser portion) including a gas discharge port is fixed by welding or the like. The cup-shaped diffuser portion may include a gas discharge port formed in one or both of a peripheral wall part and a bottom face part of a metallic cup. A housing, in which the peripheral wall part 101 and the closing member 120 are integrally formed by a deep drawing method, may be used.

When using, in the first step, a housing including the second end opening 100b to which the cup-shaped diffuser portion is fixed, or a housing in which the closing member 120 and the peripheral wall part 101 are integrally formed, the first step and the second step are omitted.

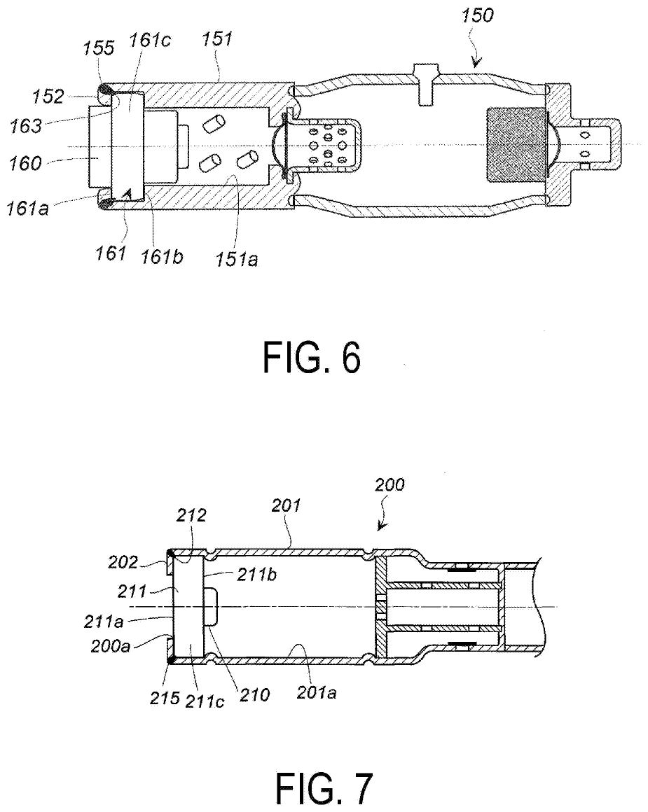

### (4) Gas Generator Illustrated in FIG. 6

A gas generator 150 illustrated in FIG. 6 is the same as the gas generator 10 illustrated in FIG. 1 of JP 2014-184427 A, except for having the closing structure according to an embodiment of the present invention. The gas generator 150 illustrated in FIG. 6 has the closing structure according to an embodiment of the present invention applied to an opening on one end side of a first cylindrical housing 151.

An igniter including an igniter collar 160 is disposed at an opening on a first end side.

The effect according to an embodiment of the present invention can be achieved whichever relationship between the first cylindrical housing 151 and the igniter collar 160 may mutually have, the relationship be a relationship, i.e., the hardness of the igniter collar 160>the hardness of the first cylindrical housing 151, or a relationship, i.e., the hardness of the igniter collar 160<the hardness of the first cylindrical housing 151.

The igniter collar 160 includes an annular protrusion 161 that serves as a closing part protruding radially outward. The annular protrusion 161 includes a second surface 161b facing inside of the first cylindrical housing 151, a first surface 161a facing outward, and a circumferential surface part 161c abutting against an inner wall surface 151a of the first cylindrical housing 151.

The first cylindrical housing 151 on the first end opening side is crimped inward to form an annular deformed part 152. The annular deformed part 152 is crimped to abut against the first surface 161a of the annular protrusion 161 of the igniter collar and a first annular corner part 163, which is a boundary between the first surface 161a and the circumferential surface part 161c. A contact portion (welded part 155) between the annular deformed part 152 and the first annular corner part 163 is welded from outside.

The welded part 155 is configured according to the embodiment illustrated in FIG. 1B, but may also be configured according to the embodiment illustrated in FIGS. 1C and 1D.

### (5) Gas Generator Illustrated in FIG. 7

A gas generator 200 illustrated in FIG. 7 is the same as the gas generator 10 illustrated in FIG. 1 of JP 2014-94614 A in which a gas generating agent and a pressurized gas are used in combination as a gas generation source, except for having the closing structure according to an embodiment of the present invention. The gas generator 200 illustrated in FIG. 7 has the closing structure according to an embodiment of the present invention applied to an opening on one end side of a first cylindrical housing 201.

An igniter 210 including an igniter collar 211 is disposed at a first end opening 200a side.

The effect according to an embodiment of the present invention can be achieved whichever relationship between the first cylindrical housing 201 and the igniter collar 211 may mutually have, the relationship being a relationship, i.e., the hardness of the igniter collar 211>the hardness of the first cylindrical housing 201, or a relationship, i.e., the hardness of the igniter collar 211<the hardness of the first cylindrical housing 201.

The igniter collar 211 includes a second surface 211b facing inside of the first cylindrical housing 201, a first surface 211a facing outward, and a circumferential surface part 211c abutting against an inner wall surface 201a of the first cylindrical housing 201.

The first cylindrical housing 201 on the first end opening 200a side is crimped inward to form an annular deformed part 202. The annular deformed part 202 is crimped to abut against the first surface 211a of the igniter collar 211 and a first annular corner part 212, which is a boundary between the first surface 211a and the circumferential surface part 211c.

A contact portion (a welded part 215) between the annular deformed part 202 and the first annular corner part 212 is welded from outside. The welded part 215 is configured according to the embodiment illustrated in FIG. 1B, but may also be configured according the embodiment illustrated in FIGS. 1C and 1D.

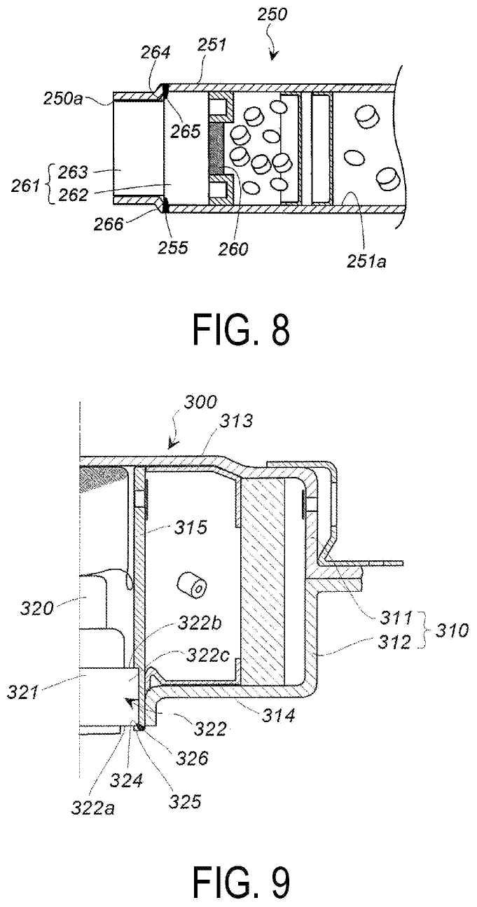

### (6) Gas Generator Illustrated in FIG. 8

A gas generator 250 illustrated in FIG. 8 is the same as the gas generator 10 illustrated in FIG. 1 of JP 2015-74413 A, except for having the closing structure according to an embodiment of the present invention. The gas generator 250 illustrated in FIG. 8 has the closing structure according to an embodiment of the present invention applied to an opening on one end side of a cylindrical housing 251.

An igniter 260 including an igniter collar 261 is disposed on a first end opening 250a side.

The effect according to an embodiment of the present invention can be achieved whichever relationship between the cylindrical housing 251 and the igniter collar 261 may mutually have, the relationship being a relationship, i.e., the hardness of the igniter collar 261>the hardness of the cylindrical housing 251, or a relationship, i.e., the hardness of the igniter collar 261<the hardness of the cylindrical housing 251.

The igniter collar 261 includes a large diameter portion 262 on the igniter 260 side and a small diameter portion 263 adjacent to the large diameter portion 262, and includes an annular stepped surface 264 created by a difference between an outer diameter of the large diameter portion 262 and an outer diameter of the small diameter portion 263 (outer diameter of the larger diameter portion 262>outer diameter of the small diameter portion 263). An annular corner part 265 is formed on the annular stepped surface 264 side of the large diameter portion 262.

The cylindrical housing 251 is processed in a manner that a diameter of a second abutting surface abutting against an outer peripheral surface of the small diameter portion 263 and the inner wall surface 251a is reduced more than a diameter of a first abutting surface abutting against an outer peripheral surface of the large diameter portion 262 and an inner wall surface 251a of the cylindrical housing. Thus, an annular stepped inclined portion (an annular deformed part) 266 is formed due to a difference between the outer diameter of the first abutting surface and the outer diameter of the second abutting surface.

The outer peripheral surface of the large diameter portion 262 of the igniter collar abuts against the inner wall surface 251a of the cylindrical housing 251. Furthermore, a slight gap is formed between the small diameter portion 263 and the inner wall surface 251a.

The annular stepped inclined portion (an annular deformed part) 266 abuts against the annular corner part 265. A contact portion (a welded part 255) between the annular stepped inclined portion (an annular deformed part) 266 and the annular corner part 265 is welded from outside. The welded part 255 is configured according to the embodiment illustrated in FIG. 1B, but may also be configured according to the embodiment illustrated in FIGS. 1C and 1D.

### (7) Gas Generator Illustrated in FIG. 9

A gas generator 300 illustrated in FIG. 9 is the same as the gas generator 1 illustrated in FIG. 2 in JP 2012-140028 A (partial cross-sectional view in FIG. 1), except for having the closing structure according to an embodiment of the present invention.

The gas generator 300 illustrated in FIG. 9 has the closing structure according to an embodiment of the present invention applied to a bottom plate 314 side of a housing 310 including a diffuser shell 311 and a closure shell 312.

An inner cylindrical member 315 is disposed in a hole at a central portion of the bottom plate 314, and an igniter 320 including an igniter collar 321 is disposed on the inside of the inner cylindrical member 315.

The effect according to an embodiment of the present invention can be achieved whichever relationship between the housing 310 and igniter collar 321 may mutually have, the relationship being a relationship, i.e., the hardness of the igniter collar 321>the hardness of the housing 310, or a relationship, i.e., the hardness of the igniter collar 321<the hardness of the housing 310.

The inner cylindrical member 315 is fixed, on a first end opening side thereof, to a top plate 313 and closed, and protrudes, on a second end opening side thereof opposite to the first end opening, slightly outward from the bottom plate 314. In the present embodiment, the inner cylindrical member 315 serves as the cylindrical opening 35 in the embodiment illustrated in FIGS. 3 and 4.

The igniter collar 321 includes an annular protrusion 322 protruding radially outwardly like the igniter collar 160 illustrated in FIG. 6. The annular protrusion 322 includes a second surface 322b facing inward, a first surface 322a facing outward, a circumferential surface part 322c between the first surface 322a and the second surface 322b, and a first annular corner part 324 between the first surface 322a and the circumferential surface part 322c, and the circumferential surface part 322c is fitted into an annular stepped surface formed in the inner cylindrical member 315.

The inner cylindrical member 315 on the opening side protruding outward is crimped inward to form an annular deformed part 325, and the annular deformed part 325 abuts against both the first surface 322a and the first annular corner part 324 of the annular protrusion 322.

A contact part (a welded part 326) between the annular deformed part 325 and the first annular corner part 324 is welded from outside. Examples of the welding method include laser welding and electron beam welding. The welded part 326 is configured according to the embodiment illustrated in FIG. 1B, but may also be configured according to the embodiment illustrated in FIGS. 1C and 1D.

Next, a manufacturing method for manufacturing the gas generator 300 illustrated in FIG. 9 will be described.

In a first step, necessary components such as a gas generating agent, a cylindrical filter, and a retainer, for example, are provided and arranged in the diffuser shell 311 to which the inner cylindrical member 315 is attached.

After that, the diffuser shell 311 and the closure shell 312 are combined to form the housing 310, and the contact portion is then welded.

In a second step, the igniter 320 including a transfer charge or the igniter collar 321 is inserted from the second end opening of the inner cylindrical member 315. At this time, the igniter 320 is inserted, with the second surface 322b of the annular protrusion 322 of the igniter collar 321 facing inward and abutting against a stepped surface of the inner cylindrical member 315, the first surface 322a facing outward, and the circumferential surface part 322c abutting against an inner wall surface of the inner cylindrical member 315.

In a third step, the peripheral wall part of the second end opening of the inner cylindrical member 315 is crimped inward until the peripheral wall part abuts against the first surface 322a and the first annular corner part 324 of the annular protrusion 322 of the igniter collar 321 to form the annular deformed part 325. As the crimping method, a rolling-crimping method similar to that described above can be applied.

In a fourth step, the contact portion (a welded part 326) between the first annular corner part 324 of the annular protrusion 322 of the igniter collar 321 and the annular deformed part 325 is welded from outside. Examples of the welding method include laser welding and electron beam welding.

### EXAMPLES

### Example 1, Comparative Example 1

A cylindrical pressure-resistant container having the closing structure illustrated in FIG. 1A (Example 1) and a cylindrical pressure-resistant container illustrated in FIG. 10A (Comparative Example 1) were prepared. Note that the closing members 13 and 400 of Example 1 and Comparative Example 1, respectively, had almost identical corners, and a difference in hardness between the cylindrical container 10 and the closing member 13 was different from a difference in hardness between the cylindrical container 410 and the closing member 400. In addition, the pressure-resistance container used in Example 1 and the pressure-resistance container used in Comparative Example 1 were same except that the positions of welding were different, and, moreover, the welding conditions were the same.

A state of the annular deformed part 15 or the annular deformed part 411 was observed when a metal rod having a similar inner diameter to that of the cylindrical pressure-resistant container was pushed into the cylindrical pressure-resistant container from the opening on the opposite side thereof in each of Example 1 and Comparative Example 1.

The results are illustrated in Table 1.

TABLE 1

| | | |
|---|---|---|
| Hardness difference (ΔHv) | ΔHv = −60 | ΔHv = 60 |
| Comparative Example 1 | Bending Mode | Shearing mode |
| Example 1 | Shearing mode | Shearing mode |

ΔHv = Vickers hardness of closing member (Hv1) − Vickers hardness of pressure-resistant container (Hv2)

As is clear from Table 1, it was confirmed that because the pressure-resistant container of Example 1 always maintained breakage in a shearing mode regardless of a difference between the hardness of the pressure-resistant container and the hardness of the closing member, the container of Example 1 can exhibit a superior closing function with respect to a large load from inside to that of the container of Comparative Example 1.

The pressure-resistant container of Comparative Example 1 had a corner part in the closing member 400, and could maintain a shear mode, with the corner of the closing member digging into the annular deformed part when a relationship, i.e., the hardness of the closing member>the hardness of the pressure-resistant container, was established, but began to assume a bending mode, with the corner of the closing member not digging into the annular deformed part when a relationship, i.e., the hardness of the closing member<the hardness of the pressure-resistant container, was established. Therefore, the withstand load in Comparative Example 1 was lower than that in Example 1. In other words, in order to ensure sufficient pressure resistance performance in Example 1, it is essential to form a corner and satisfy the relationship, i.e., the hardness of the closing member>the hardness of the pressure-resistant container.

In embodiments of the present invention, the high pressure resistance performance can be exhibited not only in a relationship, i.e., the hardness of the closing member>the hardness of the pressure-resistant container but also in a relationship, i.e., of the hardness of the closing member<the hardness of the pressure-resistant container, hence low-cost soft metal can be used in place of high-cost hard metal, and the production costs can be reduced due to an increase in options of the material and options of methods for processing members, and the like.

An aspect of the present invention has been described as above. Of course, the aspect of the present invention includes various forms of modifications within the scope thereof, and these modifications are not departures from the scope of the invention. All of what a person with ordinary skill in the art will clearly consider as a variation of the aspect of the present invention is within the scope of the claims set forth below.

1-7. (canceled)

8. A closing structure of a pressure-resistant container in which an opening of a metallic cylindrical container is closed by a metallic closing member,
the closing member including a closing part, the closing part including a first surface, a second surface on an opposite side to the first surface in a thickness direction, and a circumferential surface part between the first surface and the second surface, and having a same shape as that of the opening and having a size enabling insertion thereof into the opening,
the closing structure, comprising:
the closing member that is inserted to be at an inside of the opening of the cylindrical container, with the second surface facing inside of the cylindrical container;
an annular deformed part that is deformed, with a peripheral wall part on the opening of the cylindrical container abutting against the first surface of the closing part of the closing member and a first annular corner part at a boundary between the first surface and the circumferential surface part; and
a welded part where a contact portion between the first annular corner part of the closing part of the closing member and the annular deformed part is welded from outside.

9. A closing structure of a pressure-resistant container in which a cylindrical opening of a metallic container is closed by a metallic closing member,
the closing member including a closing part, the closing part including a first surface, a second surface on an opposite side to the first surface in a thickness direction, and a circumferential surface part between the first surface and the second surface, and having a same shape as that the cylindrical opening and having a size enabling insertion thereof into the cylindrical opening,
the closing structure, comprising:
the closing member that is inserted to be at an inside of the cylindrical opening, with the second surface facing inside of the metallic container;
an annular deformed part that is deformed, with a peripheral wall part on the cylindrical opening abutting against the first surface of the closing part of the closing member and a first annular corner part at a boundary between the first surface and the circumferential surface part; and
a welded part where a contact portion between the first annular corner part of the closing part of the closing member and the annular deformed part is welded from outside.

10. A gas generator in which a gas source is filled in a housing including a gas discharge port, and a component including an igniter actuated by an ignition current is provided in an opening of the housing,
the gas generator using the closing structure of the pressure-resistant container according to claim 8 in the opening to which an igniter including at least an igniter collar is fixed.

11. A gas generator in which a gas source is filled in a housing including a gas discharge port, and a component including an igniter actuated by an ignition current is provided in an opening of the housing,
the gas generator using the closing structure of the pressure-resistant container according to claim 9 in the opening to which an igniter including at least an igniter collar is fixed.

12. A formation method for forming the closing structure of the pressure-resistant container according to claim 8, the formation method, comprising:
inserting the closing member to be at an inside of an opening of the cylindrical container, with a second surface of a closing part facing inward and a first surface facing outward;
deforming a peripheral wall part on the opening side of the cylindrical container until the peripheral wall part abuts against a first annular corner part of the closing part of the closing member to form an annular deformed part; and
welding from outside a contact portion between the first annular corner part of the closing part of the closing member and the annular deformed part.

13. A formation method for forming the closing structure of the pressure-resistant container according to claim 9, the formation method, comprising:
inserting the closing member to be at an inside of the cylindrical opening, with a second surface of a closing part facing inward and a first surface facing outward;
deforming a peripheral wall part on the cylindrical opening until the peripheral wall part abuts against a first annular corner part of the closing part of the closing member to form an annular deformed part; and
welding from outside a contact portion between the first annular corner part of the closing part of the closing member and the annular deformed part.

14. A manufacturing method for manufacturing a gas generator including the closing structure of the pressure-resistant container according to claim 8, the manufacturing method, comprising:
providing and arranging a gas source and another component, as necessary, in a cylindrical container including a gas discharge port that is formed in advance;
inserting an igniter including a metallic igniter collar provided with the closing part from a first end opening of the cylindrical container;
deforming a peripheral wall part on the first end opening side of the cylindrical container until the peripheral wall part abuts against a first annular corner part of a closing part of the igniter collar to form a first annular deformed part; and
welding from outside a contact portion between the first annular corner part of the igniter collar and the first annular deformed part.

15. A manufacturing method for manufacturing a gas generator including the closing structure of the pressure-resistant container according to claim 9, the manufacturing method, comprising:
providing and arranging a gas source, an igniter, and another component, as necessary, in a metallic container including a gas discharge port formed in advance;
inserting an igniter including a metallic igniter collar provided with the closing part to be at an inside of a cylindrical opening of the metallic container, with a second surface of the closing part facing inward and a first surface facing outward;
deforming a peripheral wall part of the cylindrical opening of the metallic container inward until the peripheral wall part abuts against a first annular corner part of the igniter collar to form an annular deformed part, and
welding from outside a contact portion between the first annular corner part of the closing member and the annular deformed part.
